(19) United States
(12) Patent Application Publication
(10) Pub. No.: US 2023/0222269 A1
(43) Pub. Date: Jul. 13, 2023

(54) DESIGNING NANOFLUIDS FOR SUBSURFACE APPLICATIONS

(71) Applicant: SAUDI ARABIAN OIL COMPANY, Dhahran (SA)

(72) Inventors: Nouf Mohammed Al-Jabri, Dammam (SA); Klemens Katterbauer, Dhahran (SA); Alberto Marsala, Venezia (IT)

(73) Assignee: SAUDI ARABIAN OIL COMPANY, Dhahran (SA)

(21) Appl. No.: 17/647,935

(22) Filed: Jan. 13, 2022

(51) Int. Cl. G06F 30/27

(52) U.S. Cl. CPC G06F 30/27; G06F 2113/08

(57) ABSTRACT

A method includes establishing a database including one or more characteristics of one or more reactants and a historical data subset; determining, utilizing a machine learning algorithm trained with data stored in the database, a combination of the reactants and a reaction condition to be used for synthesis of a nanofluid; and synthesizing the nanofluid based on the combination of reactants and the reaction condition.

### BACKGROUND

Applying nanomaterials is an emerging technology in petroleum engineering. For example, nanofluids may be used for subsurface applications such as enhanced oil recovery applications (EOR), mud decontamination, and drilling fluids. Nanofluids are engineered colloidal suspensions of nanoparticles in a base liquid. Nanofluids injection may have an effect to disjoining pressure, pore channels plugging, and modification of wettability, viscosity, and interfacial properties. Nanofluids injection into reservoirs can improve oil displacement and injectivity. However, nanofluids may be destabilized under harsh reservoir conditions. Increased salinity, pressure, or temperature in the reservoirs sets a challenge to maintain the functionality of the injected nanofluids. Therefore, there exists a challenge and a need for designing optimal functionalized and stabilized nanofluids.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method including: establishing a database comprising one or more characteristics of one or more reactants and a historical data subset; determining, utilizing a machine learning algorithm trained with data stored in the database, a combination of the reactants and a reaction condition to be used for synthesis of a nanofluid; and synthesizing the nanofluid based on the combination of reactants and the reaction condition. The reactants include one or more of a nanoparticle, a surfactant, and a stabilizer. The historical data subset comprises stability data of known combinations. The historical data subset comprises cost data of the reactants. The machine learning algorithm utilizes a deep belief network. The determining step utilizes the machine learning algorithm to obtain the combination of reactants and the reaction condition such that the nanofluid synthesized based on the combination and the reaction condition is stable in a brine for a period of time. The reaction condition defines concentrations of each reactant in the combination.

In another aspect, embodiments disclosed herein relate to a system including: a memory comprising a database configured to store one or more characteristics of one or more reactants and a historical data subset; and a processor configured to determine, utilizing a machine learning algorithm trained on the database, a combination of the reactants and a reaction condition to be used for synthesis of a nanofluid. The reactants include one or more of a nanoparticle, a surfactant, and a stabilizer. The memory comprises the historical data subset including stability data of known combinations. The memory comprises the historical data subset including cost data of the reactants. The processor is configured to perform the machine learning algorithm utilizing a deep belief network. The processor is configured to utilize the machine learning algorithm to obtain the combination of the reactants and the reaction condition such that the nanofluid synthesized based on the combination and the reaction condition is stable in a brine for a period of time. The reaction condition defines concentrations of each reactant in the combination.

In yet another aspect, embodiments disclosed herein relate to a non-transitory computer readable medium storing instructions executable by a computer processor, the instructions comprising functionality for: obtaining a database comprising one or more characteristics of one or more reactants and a historical data subset; and determining, utilizing a machine learning algorithm trained with the database, a combination of reactants and a reaction condition for synthesis, wherein the combination and the reaction condition are subsequently used in the synthesis of a nanofluid. The reactants include one or more of a nanoparticle, a surfactant, and a stabilizer. The historical data subset comprises stability data of known combinations. The historical data subset comprises cost data of the reactants. The machine learning algorithm utilizes a deep belief network. The instructions comprise functionality for utilizing the machine learning algorithm to obtain the combination and the reaction condition such that the nanofluid synthesized based on the combination and the reaction condition is stable in a brine for a period of time.

Other aspects and advantages of the claimed subject matter will be apparent from the following description and the appended claims.

### BRIEF DESCRIPTION OF DRAWINGS

FIG. 1 shows a system according to one or more embodiments.

FIG. 2 shows a flowchart of a method for designing nanofluids, according to one or more embodiments.

FIG. 3 shows a scheme of a deep belief network architecture, according to one or more embodiments.

FIG. 4 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

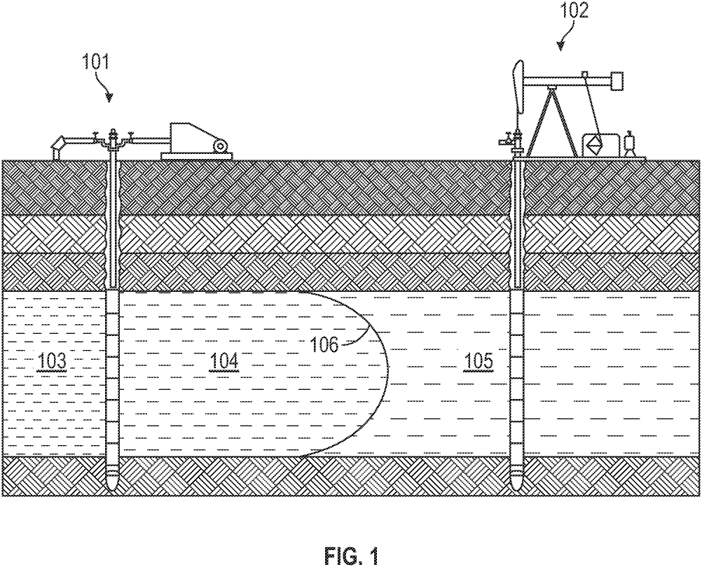

Embodiments of the present invention provide a system utilizing nanofluids for subsurface applications. FIG. 1 shows a schematic diagram in accordance with one or more embodiments. As illustrated in FIG. 1, the system may include an injection well (101) and a production well (102). Injection fluids may be injected through the injection well into a subsurface reservoir using an injection device, such as a pump. The injection fluids may be driven by a water bank (water or brine) (104) that moves through a formation within the reservoir (103). The injection fluids mobilize trapped and bypassed oil and forces mobilized oil (105) (hydrocarbons) towards the production well (102). The production well may comprise a lifting system, such as a pump, for elevating mobilized oil to surface. The injection fluids may comprise nanofluids designed and synthesized according to embodiments of the present invention. At an interface (106) between the water bank and the mobilized oil, nanofluids may alter wettability and reduce interfacial tension (IFT). The nanofluids injection may be part of an enhanced oil recovery (EOR) process following a secondary recovery. The nanofluids injection may be part of an EOR operation following a primary recovery. The nanofluids injection may be followed by carbon dioxide injection or brine to maximize a sweep efficiency. FIG. 1 is provided as one exemplary application of nanofluids for subsurface applications. However, one of ordinary skill in the art would recognize that the system of FIG. 1 is non-limiting and that nanofluids may be used for other subsurface applications, such as drilling.

One or more embodiments of the present invention relate to a method of designing nanofluids for subsurface applications. One or more steps of the method may relate to an optimization process, optimizing a combination of reactants and a reaction condition for nanofluids synthesis. One or more steps of the method may relate to a synthesis process, utilizing the optimized combination and reaction condition from the optimization process for nanofluids synthesis. One or more steps of the method disclosed herein may involve a machine-learning (ML) algorithm. The following example is for explanatory purposes only and not intended to limit the scope of the disclosed technology.

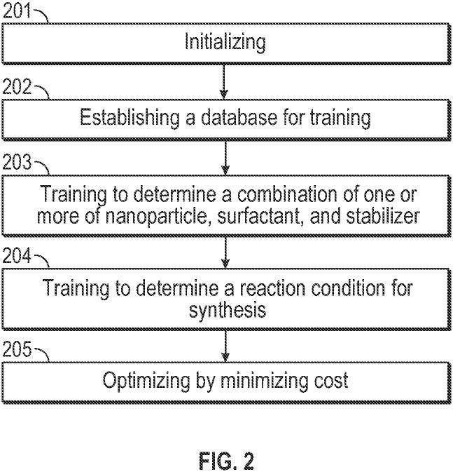

FIG. 2 shows a flowchart of the optimization process for designing nanofluids, according to one or more embodiments. The optimization process may include an initializing step (201) by analyzing compositions of one or more reactants and identifying a synthesis process for preparing nanofluids. Furthermore, the molecular build-up and charge analysis is analyzed in order to determine correlations between the composition and the molecular structure. The reactants used for nanofluids synthesis may include nanoparticles, a surfactant, and a stabilizer (co-surfactant).

In step (202), a database for training is established. The database may be any repository for storing one or more characteristics of one or more reactants, for example nanoparticles, surfactants, and stabilizers, that may potentially be used for nanofluids synthesis. Further, the database may be stored on any computing device operatively connected to the system.

In step (203), a first training step performs training on the database, employing one or more ML algorithms, to determine one or more optimal combinations of one or more reactants. The reactants may include nanoparticles, surfactant, and stabilizer. In one or more embodiments, an optimal combination of surfactant and stabilizer with a desired stability is determined.

In step (204), a second training step performs training, employing one or more ML algorithms, to determine a reaction condition for synthesis. The reaction condition may include concentration of one or more of reactants, temperature, reaction time, etc.

In step (205), an optimization routine is performed to obtain optimized results with minimized overall cost and desired stability. The optimized results include one or more combinations of reactants and reaction conditions and may be subsequently used for nanofluids synthesis.

While a plurality of steps are described, the steps are non-limiting and are for illustration purpose only. It will be apparent to one of ordinary skill in the art that some steps may be executed in different orders, may be omitted, combined, or executed in parallel.

One or more of the aforementioned steps may utilize ML algorithms that are unsupervised, reinforcement, supervised, or semi-supervised learning. More specifically, supervised ML algorithms may include classification, regression models, etc. Unsupervised ML algorithms may include, for example, clustering models. Deep learning algorithms are a part of ML algorithms based on artificial neural networks with representation learning. For example, deep learning algorithms may run data through multiple layers of neural network algorithms, each of which passes a simplified representation of the data to the next neighboring layer. More specifically, each artificial neural network consists of a plurality of neurons that are stacked next to each other and organized in layers. Each neuron may receive various inputs, multiplies the inputs by weights, sums them up, and applies a non-linear function. Each neuron may receive data from all neurons presented in a previous neighboring layer and sends processed data to all neurons in the next neighboring layer. The neurons of a layer are connected to all the neurons of the neighboring layers. Deep learning algorithms are particularly used when a large number of parameters are involved and require access to a vast amount of data to be effective. In one or more embodiments, the deep learning algorithm may utilize one or more neural network architectures, such as but not limited to, convolutional neural networks, recurrent neural networks, general adversarial neural networks, deep belief networks, autoencoders, etc.

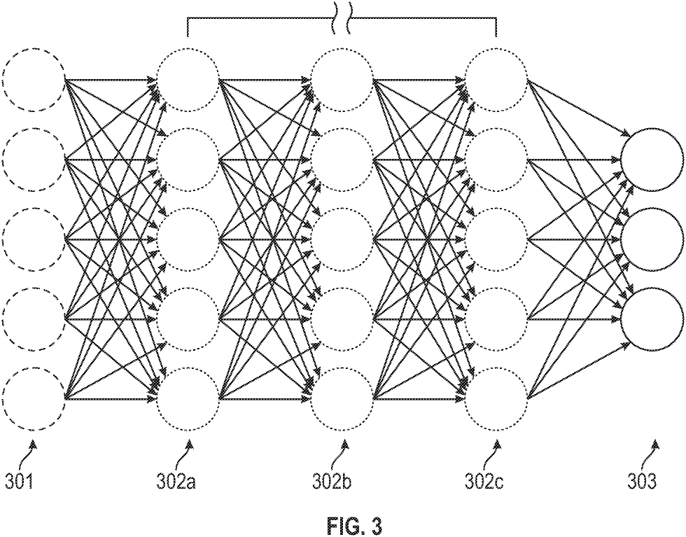

One or more of the steps may utilize a ML algorithm with an architecture including a deep belief network (DBN). The following example is for explanatory purposes only and not intended to limit the scope of the disclosed technology. FIG. 3 shows a scheme of a ML algorithm architecture that includes DBN. The DBN is composed of stacked layers of Restricted Boltzmann Machines (RBMs) and is be used to solve unsupervised learning tasks to reduce the dimensionality of features. DBN may be used to solve supervised learning tasks to build classification models or regression models. The training in DBN comprises layer-by-layer training and fine-tuning. Layer-by-layer training performs unsupervised training of each RBM, and fine-tuning uses error back-propagation algorithms to fine-tune the learning parameters of DBN after the unsupervised training is finished. The learning parameters (or hyperparameters) are set before the learning begins, based on specific implementation or problem. The learning parameters may comprise number of layers, learning rate, activation function, and weighting factors. The learning parameters may change with learning progress of the DBN.

The DBN architecture may comprise a first layer as an input layer (301) for receiving input data. The input data received may be initialized to establish a database for training. Specifically, the database may comprise data with regard to sizes, surface charges, types, and geometries of a plurality of nanoparticles. Surface charges may present as positive, negative, neutral, optionally with number of charges. The nanoparticles may be metal oxide nanoparticles, including but not limited to, zinc oxide, magnesium oxide, nickel oxide, calcium oxide, zirconium oxide, manganese oxide, iron oxide, aluminum oxide, titanium oxide, silicon oxide, and copper oxide. In one or more embodiments, the nanoparticles may be superparamagnetic iron oxide nanoparticles (SPIONs). The nanoparticles may also be other types of nanoparticles, such as carbon nanoparticles (e.g., dots, nanotubes), quantum dots, ash nanoparticles, and date seed nanoparticles. Examples of geometries may include sphere, rod, sheet, cylinder, prism, etc. A size of nanoparticles may be varied based on specific requirement for different types and is non-limiting. In one or more embodiments, the nanoparticles may have a size of smaller than 100 nm.

In one or more embodiments, the database may comprise data with regard to functional groups, molecular structures, and charges of a plurality of surfactants. The database may include data with regard to functional groups, molecular structures, and charge of a plurality of stabilizers. Examples of functional groups may include alkane, alkene, alkyne, phenyl, amine, alcohol, ether, alkyl halide, thiol, aldehyde, ketone, ester, carboxylic acid, amide, etc. Charges may present as positive, negative, neutral, optionally with number of charges. Molecular structures may regard to arrangement of atoms or functional groups.

In one or more embodiments, the database may comprise historical data with regard to stability of known combinations, cost of reactants, and experimental data regarding reaction conditions, such as concentrations of reactants, temperature, etc. The stability may be evaluated in any manner known to one having ordinary skill in the art. For example, the stability may be evaluated based on whether particle size changes when disposed in water or brine. The stability may be evaluated based on a period of time that particle size stays unchanged in water or brine. The database may be classified by outlining the stability of the various combinations.

The DBN architecture may comprise a last layer as an output layer (302) for outputting results. The output results may comprise recommendation with regard to one of more of a combination of surfactant and stabilizer; a combination of nanoparticles, surfactant and stabilizer; type, size, charge, and geometry of nanoparticles; and reaction conditions, such as concentration, temperature, etc. The output results with reduced cost and desired stability may be used subsequently for nanofluids synthesis.

In one or more embodiments, the architecture comprises one or more hidden layers (303) between the input and output layer. The number of the hidden layers may depend on the volume and complexity of the database. In one or more embodiments, a number of hidden layers may be three, or five, or more. In the example of FIG. 3, a first hidden layer (303a), a second hidden layer (303b), and a third hidden layer (303c) are provided for illustration purpose only. The DBN learns one layer at a time in an unsupervised way, and then undergoes fine-tuning via supervised learning with backpropagation. Except for the first layer and the last layer, each layer in a DBN performs a dual role by serving as the hidden layer to the nodes that come before it and as an input layer to the nodes that come after.

One or more of the hidden layers may be configured to generate one or more combinations of one or more reactants. In one or more embodiments, a combination of surfactant and stabilizer may be generated. In one or more embodiments, type, size, surface charge, and geometry of a nanoparticle may be generated. In one or more embodiments, a combination of nanoparticle, surfactant, and stabilizer may be generated.

One or more of the hidden layers may be configured to generate a reaction condition for one or more reactants, for example concentration, temperature, duration of reaction, etc.

One or more of the hidden layers may be configured to generate a combination of one or more reactants or a reaction condition based on stability. Specifically, the one or more hidden layer may be configured to generate the combination or the reaction condition such that a nanofluid synthesized using the combination or the reaction condition has a desired stability. The desired stability may refer to a stability of the nanofluid in a brine for a period of time.

One or more of the hidden layers may be configured to perform an optimization routine to obtain one or more optimized reaction conditions for a combination of nanoparticles, surfactant, and stabilizer with minimized overall cost while maintaining a desired stability. The optimized combination and reaction conditions may be subsequently used for nanofluids synthesis.

Any result obtained from one or more of the hidden layers may serve as an intermediate result. The intermediate result may be obtained from any one of the hidden layers, despite the number of hidden layers. The intermediate result may serve as input for a following layer, either another hidden layer or the output layer. For example, the intermediate result may be obtained from the second hidden layer (303b). The intermediate result obtained from the second hidden layer (303b) may then be used as input data for a following hidden layer, namely the third hidden layer (303c).

According to one or more embodiments, the method of designing nanofluids for subsurface applications may comprise synthesizing nanofluids based on optimized combination and reaction condition obtained in the optimization process as previously described. The nanofluids synthesis may be performed by encapsulating nanoparticles in a surfactant to form micelles and subsequently stabilizing with a stabilizer (co-surfactant). In one or more embodiments, the nanofluids synthesis comprises mixing a first solution containing the nanoparticles with a second solution containing the surfactant to form a micelle solution. The nanofluids synthesis may further comprise mixing the micelle solution with a third solution containing the stabilizer to for a nanofluids solution. The nanofluids synthesis may be performed at room temperature. Alternatively, the nanofluids synthesis may be performed at elevated temperature. In one or more embodiments, the nanofluids synthesis may be performed under continuous stirring.

One or more embodiments of the present disclosure relate to compositions of designed nanofluids using the method disclosed herein. The nanofluids may exhibit excellent colloidal stability at room temperature or at an elevated temperature. For example, the nanofluids may be stable at a temperature of more than 40° C., or more than 50° C., or more than 70° C., or more than 90° C., for a period of time. The nanofluids may be stable in a brine with a degree of salinity, for a period of time. For example, the brine may have a degree of salinity of more than 10,000 parts per million (ppm), or more than 20,000 ppm, or more than 30,000 ppm, or more than 50,000 ppm, or more than 100,000 ppm, based on a content of salt in water. The period of time may be hours, or days, or weeks, or months. In one or more embodiments, the period of time may be more than one month, or may be two months. The nanofluids may reduce an interfacial tension (IFT) between crude oil and water. For example, the nanofluids may reduce the IDF to lower than 5 mN/m, or lower than 1 mN/m, or lower than 0.50 mN/m, or lower than 0.10 mN/m, or lower than 0.05 mN/m, or lower than 0.02 mN/m.

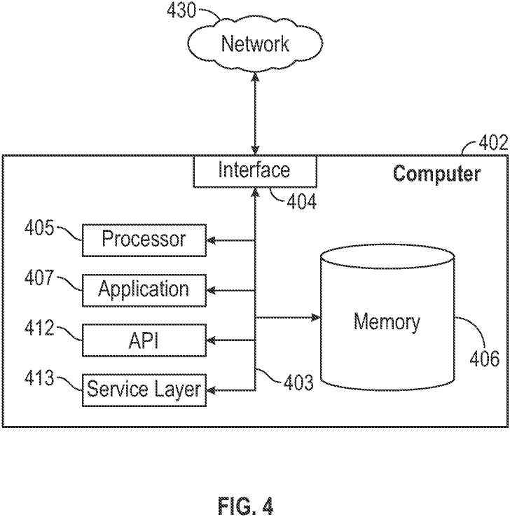

One or more embodiments of the present disclosure may be implemented on a computing device. FIG. 4 is a block diagram of a computing device (402) used to provide computational functionalities associated with described algorithms, methods, functions, processes, flows, and procedures as described in the present disclosure. For example, the ML algorithms for the artificial intelligence model that is used for optimization of nanofluids synthesis may be implemented on such a computing device. The illustrated computer (402) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (402) may include a computer that includes an input device, such as a keypad, keyboard, touch screen, or other device that can accept user information, and an output device that conveys information associated with the operation of the computer (402), including digital data, visual, or audio information (or a combination of information), or a GUI. In one or more embodiments, the input device may be configured to input at least the database and the learning parameters for the method described herein.

The computer (402) can serve in a role as a client, network component, a server, a database or other persistency, or any other component (or a combination of roles) of a computer system for performing the subject matter described in the present disclosure. The illustrated computer (402) is communicably coupled with a network (430). In some implementations, one or more components of the computer (402) may be configured to operate within environments, including cloud-computing-based, local, global, or other environment (or a combination of environments).

At a high level, the computer (402) is an electronic computing device operable to receive, transmit, process, store, or manage data and information associated with the described subject matter. According to some implementations, the computer (402) may also include or be communicably coupled with an application server, e-mail server, web server, caching server, streaming data server, business intelligence (BI) server, or other server (or a combination of servers).

The computer (402) can receive requests over network (430) from a client application (for example, executing on another computer (402)) and responding to the received requests by processing the said requests in an appropriate software application. In addition, requests may also be sent to the computer (402) from internal users (for example, from a command console or by other appropriate access method), external or third-parties, other automated applications, as well as any other appropriate entities, individuals, systems, or computers.

Each of the components of the computer (402) can communicate using a system bus (403). In some implementations, any or all of the components of the computer (402), both hardware or software (or a combination of hardware and software), may interface with each other or the interface (404) (or a combination of both) over the system bus (403) using an application programming interface (API) (412) or a service layer (413) (or a combination of the API (412) and service layer (413). The API (412) may include specifications for routines, data structures, and object classes. The API (412) may be either computer-language independent or dependent and refer to a complete interface, a single function, or even a set of APIs. The service layer (413) provides software services to the computer (402) or other components (whether or not illustrated) that are communicably coupled to the computer (402). The functionality of the computer (402) may be accessible for all service consumers using this service layer. Software services, such as those provided by the service layer (413), provide reusable, defined business functionalities through a defined interface. For example, the interface may be software written in JAVA, C++, or other suitable language providing data in extensible markup language (XML) format or other suitable formats. While illustrated as an integrated component of the computer (402), alternative implementations may illustrate the API (412) or the service layer (413) as stand-alone components in relation to other components of the computer (402) or other components (whether or not illustrated) that are communicably coupled to the computer (402). Moreover, any or all parts of the API (412) or the service layer (413) may be implemented as child or sub-modules of another software module, enterprise application, or hardware module without departing from the scope of this disclosure.

The computer (402) includes an interface (404). Although illustrated as a single interface (404) in FIG. 4, two or more interfaces (404) may be used according to particular needs, desires, or particular implementations of the computer (402). The interface (404) is used by the computer (402) for communicating with other systems in a distributed environment that are connected to the network (430). Generally, the interface (404) includes logic encoded in software or hardware (or a combination of software and hardware) and operable to communicate with the network (430). More specifically, the interface (404) may include software supporting one or more communication protocols associated with communications such that the network (430) or interface’s hardware is operable to communicate physical signals within and outside of the illustrated computer (402).

The computer (402) includes at least one computer processor (405). Although illustrated as a single computer processor (405) in FIG. 4, two or more processors may be used according to particular needs, desires, or particular implementations of the computer (402). Generally, the computer processor (405) executes instructions and manipulates data to perform the operations of the computer (402) and any algorithms, methods, functions, processes, flows, and procedures as described in the present disclosure.

The computer (402) also includes a memory (406) that holds data for the computer (402) or other components (or a combination of both) that can be connected to the network (430). For example, memory (406) can be a database storing data consistent with this disclosure. Although illustrated as a single memory (406) in FIG. 4, two or more memories may be used according to particular needs, desires, or particular implementations of the computer (402) and the described functionality. While memory (406) is illustrated as an integral component of the computer (402), in alternative implementations, memory (406) can be external to the computer (402).

The application (407) is an algorithmic software engine providing functionality according to particular needs, desires, or particular implementations of the computer (402), particularly with respect to functionality described in this disclosure. For example, application (407) can serve as one or more components, modules, applications, etc. Further, although illustrated as a single application (407), the application (407) may be implemented as multiple applications (407) on the computer (402). In addition, although illustrated as integral to the computer (402), in alternative implementations, the application (407) can be external to the computer (402).

Software instructions in the form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the disclosure.

There may be any number of computers (402) associated with, or external to, a computer system containing computer (402), each computer (402) communicating over network (430). Further, the term “client,” “user,” and other appropriate terminology may be used interchangeably as appropriate without departing from the scope of this disclosure. Moreover, this disclosure contemplates that many users may use one computer (402), or that one user may use multiple computers (402).

One or more embodiments of the present invention provides a feasible and efficient method of designing nanofluids. Employment of machine learning technique advantageously saves time and cost by avoiding large amount of experiments. The method according to one or more embodiments of the present invention provide nanofluids with desired stability, reduced IFT, reduced overall cost, and possibility of scaling up for field applications.

Embodiments disclosed herein provide a sustainable method to utilize a diluted amount of chemicals to produce efficient nanofluids for subsurface applications, by a data-driven automated NF construction. The process used herein stabilizes nanoparticles (e.g., metal oxide nanoparticles), surfactant, and cosurfactant under reservoir conditions, reduces the needed amount of the injected chemicals, and reduces the classical surfactant-EOR cost. As previously described, the current designed nanoparticles are stable at 90° C. and in the presence of divalent ions for 2 months and still all the formulation are under observation. Contrary to surfactant, the nanofluids’ capsules can deliver the needed chemicals to deeper layer in reservoirs. Further, there is a higher efficiency due to the synergy between surfactant, co-surfactants, and nanoparticles.

### EXAMPLES

The following examples are merely illustrative and should not be interpreted as limiting the scope of the present disclosure.

### Example 1

TABLE 1

| | | | |
|---|---|---|---|
| Sample | Stability in brine under room temperature | Stability in brine under 90 - 100° C. | IFT (mN/m) |
| #1 ZnO-NF | Yes | Yes | 0.07 |
| #2 ZrO₂-NF | Yes | Yes | - |
| #3 SPION-NF (5 nm) | Yes | Yes | 0.01 |
| #4 SPION-NF (50 nm) | Yes | Yes | 0.02 |
| #5 MnO-NF | Yes | Yes | - |

A plurality of nanofluid (NF) samples were prepared, as shown in Table 1. The combination of reactants and reaction condition used for synthesis were optimized according to one or more embodiments of the present invention described above. The plurality of NF samples#1-5 were synthesized by mixing a nanoparticles solution with a surfactant solution to obtain a micelle solution. The micelle solution was subsequently mixed with a stabilizer solution to obtain desired NF samples. The mixing of solutions was performed under room temperature. The as-synthesized NF samples #1-5 included zinc oxide encapsulated nanofluid (ZnO-NF), zirconium oxide encapsulated nanofluid (ZrO₂-NF), SPION encapsulated nanofluid (SPION-NF) having a size of 5 nm, SPION-NF having a size of 50 nm, and manganese oxide encapsulated nanofluid (MnO-NF). Unless specified, a size of nanoparticles in the NF samples was smaller than 50 nm. The surfactant was a petroleum sulfonate salt, and the stabilizer was zwitterionic cocamidopropyl hydroxysultaine.

All NF samples showed excellent stability in a brine having a salinity of 56,000 ppm under room temperature, as shown in Table 1. For all NF samples, no sedimentation was observed visually for one month.

All NF samples showed excellent stability in a brine having a salinity of 56,000 ppm under an elevated temperature from 90 to 100° C., as shown in Table 1. For all NF samples, no sedimentation was observed visually for one month.

An interfacial tension (IFT) between crude oil and brine may be in a range of from about 35 to about 65 mN/m. NF samples synthesized using ZnO and SPION nanoparticles showed reduced IFT between crude oil and water by orders of magnitude, as shown in Table 1.

Unless defined otherwise, all technical and scientific terms used have the same meaning as commonly understood by one of ordinary skill in the art to which these systems, apparatuses, methods, processes, and compositions belong.

Although the preceding description has been described here with reference to particular means, materials, and embodiments, it is not intended to be limited to the particulars disclosed here; rather, it extends to all functionally equivalent structures, methods and uses, such as those within the scope of the appended claims.

The ranges of this disclosure may be expressed in the disclosure as from about one particular value, to about another particular value, or both. When such a range is expressed, it is to be understood that another embodiment is from the one particular value, to the other particular value, or both, along with all combinations within this range.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112(f) for any limitations of any of the claims herein, except for those in which the claim expressly uses the words ‘means for’ together with an associated function.

What is claimed:

1. A method comprising:
establishing a database comprising one or more characteristics of one or more reactants and a historical data subset;
determining, utilizing a machine learning algorithm trained with data stored in the database, a combination of the reactants and a reaction condition to be used for synthesis of a nanofluid; and
synthesizing the nanofluid based on the combination of reactants and the reaction condition.

2. The method of claim 1, wherein the reactants include one or more of a nanoparticle, a surfactant, and a stabilizer.

3. The method of claim 1, wherein the historical data subset comprises stability data of known combinations.

4. The method of claim 1, wherein the historical data subset comprises cost data of the reactants.

5. The method of claim 1, wherein the machine learning algorithm utilizes a deep belief network.

6. The method of claim 1, wherein the determining step utilizes the machine learning algorithm to obtain the combination of reactants and the reaction condition such that the nanofluid synthesized based on the combination and the reaction condition is stable in a brine for a period of time.

7. The method of claim 1, wherein the reaction condition defines concentrations of each reactant in the combination.

8. A system comprising:
a memory comprising a database configured to store one or more characteristics of one or more reactants and a historical data subset; and
a processor configured to determine, utilizing a machine learning algorithm trained on the database, a combination of the reactants and a reaction condition to be used for synthesis of a nanofluid.

9. The system of claim 8, wherein the reactants include one or more of a nanoparticle, a surfactant, and a stabilizer.

10. The system of claim 8, wherein the memory comprises the historical data subset including stability data of known combinations.

11. The system of claim 8, wherein the memory comprises the historical data subset including cost data of the reactants.

12. The system of claim 8, wherein the processor is configured to perform the machine learning algorithm utilizing a deep belief network.

13. The system of claim 8, wherein the processor is configured to utilize the machine learning algorithm to obtain the combination of the reactants and the reaction condition such that the nanofluid synthesized based on the combination and the reaction condition is stable in a brine for a period of time.

14. The system of claim 8, wherein the reaction condition defines concentrations of each reactant in the combination.

15. A non-transitory computer readable medium storing instructions executable by a computer processor, the instructions comprising functionality for:
obtaining a database comprising one or more characteristics of one or more reactants and a historical data subset; and
determining, utilizing a machine learning algorithm trained with the database, a combination of reactants and a reaction condition for synthesis,
wherein the combination and the reaction condition are subsequently used in the synthesis of a nanofluid.

16. The non-transitory computer readable medium of claim 15, wherein the reactants include one or more of a nanoparticle, a surfactant, and a stabilizer.

17. The non-transitory computer readable medium of claim 15, wherein the historical data subset includes stability data of known combinations.

18. The non-transitory computer readable medium of claim 15, wherein the historical data subset includes cost data of the reactants.

19. The non-transitory computer readable medium of claim 15, wherein the machine learning algorithm comprises a deep belief network.

20. The non-transitory computer readable medium of claim 15, wherein the instructions comprise functionality for utilizing the machine learning algorithm to obtain the combination and the reaction condition such that the nanofluid synthesized based on the combination and the reaction condition is stable in a brine for a period of time.
